(19) United States
(12) Patent Application Publication
(10) Pub. No.: US 2008/0271624 A1
(43) Pub. Date: Nov. 6, 2008

(54) Sheet-Fed Printing Press and Printing Method

(75) Inventor: Yasunobu Kobayashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Tokyo (JP)

(21) Appl. No.: 11/885,698

(22) PCT Filed: Feb. 24, 2006
(86) PCT No.: PCT/JP2006/303413

§ 371 Date: Sep. 5, 2007

(30) Foreign Application Priority Data
Mar. 8, 2005 (JP) 2005-063517

(51) Int. Cl. B41F 35/00; B41F 5/02

(52) U.S. Cl. 101/230; 101/425

(57) ABSTRACT

A sheet-fed printing press exhibiting excellent workability is provided, in which even by powder spray in print work equal to conventional one, any printing plate can be used because wear is enhanced by the printing press body and with which low cost can be realized by eliminating the need for changing the printing plate in the middle. A single-side printing sheet-fed printing press, including a print unit, and a sheet fed section having a feeder portion for feeding a sheet to the print unit, is characterized in that at least one of the feeder portion and the print unit has a dust removing means.

### TECHNICAL FIELD

The present invention relates to a sheet-fed printing press, and in particular, to a printing press that prints by using blocking-prevention powder, specifically, to a sheet-fed printing press suitable for using a printing plate of a computer-to-plate (CTP) mode for printing.

### BACKGROUND OF THE INVENTION

With the digitization of printing data, there is a demand for CTP that is inexpensive and easy to handle and has an aptitude for printing identical to that of a presensitized plate. In recent years, in particular, there are rising expectations for thermal-processless printing plate that can be applied to a printing press that does not require photographic processing by specific drug and is equipped with direct imaging (DI) functions, and has the same utility as that of the presensitized plate.

With respect to materials for a printing plate in recent years, a so-called processless printing plate requiring no photographic process has just started to be put to practical use. For example, Japanese Patent Publication Open to Public Inspection Nos. 7-1849, 7-164773, 9-123387 and 10-193823 disclose a processless printing plate. These processless printing plates do not require an automatic processor, and they can be installed in a printing press directly for printing, after being exposed on a plate setter. However, in the case of these printing plate materials, it is difficult to give them energies sufficient to harden an image forming layer, resulting in the low hardness of the image forming layer that easily causes a printing plate surface to be damaged against shocks and foreign substances, and it has been pointed out that a plate life of the aforesaid printing plate material is inferior to that of the presensitized plate and a thermal plate which have been used previously.

Further, when viewed from the side of a machine, there has been a problem that a blanket cylinder tends to be soiled to lower printing quality easily, when printing by using blocking-prevention powder as in the past. It is therefore necessary to increase the number of times for cleaning that interrupts printing operations, which has been a problem of a decline of operation efficiency.

For the purpose of improving the aforesaid points, there have been disclosed technologies including a technology of separation and collection of powder to be used for offset printing (see Patent Document 1), a technology for promoting sticking of powder by spraying water on offsetting-prevention powder on printing paper and thereby for reducing an amount of powder used (see Patent Document 2), and a technology for preventing scattering of blocking-prevention powder by providing a dust collecting device on a sheet ejecting section of a sheet-fed printing press (see, for example, Patent Documents 3 and 4). However, a powder removing and collecting method at an exit of the sheet ejecting section is still insufficient, and workability and plate life are inferior to those of the conventional printing plate, which has been a problem.

Patent Document 1: Japanese Patent Publication Open to Public Inspection No. 7-17022

Patent Document 2: Japanese Patent Publication Open to Public Inspection No. 8-52858

Patent Document 3: Japanese Patent Publication Open to Public Inspection No. 8-295007

Patent Document 4: Japanese Patent Publication Open to Public Inspection No. 2003-320642

### DISCLOSURE OF THE INVENTION

### Problems to be Solved by the Invention

The present invention has been achieved to solve the aforesaid problems, and its objective is to provide a sheet-fed printing press wherein workability is excellent even in spraying of blocking-prevention powder in printing operations identical to those in the past, and a plate life of a printing plate is enhanced by the printing press body, whereby, a printing plate of any type can be used, a printing plate does not need to be replaced on the half way, and low cost is realized.

### Means to Solve the Problems

The aforesaid objective of the invention has been achieved by the following structures.

Item 1. A single-sided sheet-fed printing press having therein a printing unit and a sheet-feeding device having a feeder portion that feeds a sheet to the printing unit, wherein at least one of the feeder portion and the printing unit has a dust-removing device.
Item 2. The sheet-fed printing press described in Item 1 wherein the dust-removing means is a means to remove dust by blowing compressed air.
Item 3. The sheet-fed printing press described in Item 1 wherein the dust-removing means is a means to remove dust by scraping.
Item 4. The sheet-fed printing press described in Item 3 wherein the means to remove dust by scraping is at least one type selected from a brush, non-woven fabric and a blade.
Item 5. The sheet-fed printing press described in at least one of Items 1-4 wherein a further dust collecting means is provided.
Item 6. The sheet-fed printing press described in Item 5 wherein the aforesaid dust-removing means and the dust collecting means are provided in a casing which is totally of a box structure.
Item 7. A printing method conducting double-sided printing by using the sheet-fed printing press described in any one of Items 1-6, wherein dust is removed from the opposite side on the feeder portion and the aforesaid printing unit, when printing on the opposite side, after supplying blocking-prevention powder on the surface to be printed for the single-sided printing, after single-sided printing.

### EFFECT OF THE INVENTION

In the sheet-fed printing press of the invention, workability is excellent even in spraying of powder in printing operations identical to those in the past, and a plate life of a printing plate is enhanced by the printing press main body, whereby, a printing plate of any type can be used, a printing plate does not need to be replaced on the half way, and low cost is realized.

### BRIEF DESCRIPTION OF THE DRAWINGS

FIG. 1 is an overall schematic diagram of a sheet-fed printing press used for a printing method of the invention.

FIG. 2 is an enlarged schematic diagram of a sheet-fed printing press having a compressed air jetting nozzle (for removing blocking-prevention powder) on a sheet-feeding device.

FIG. 3 is an enlarged schematic diagram of a sheet-fed printing press having a compressed air jetting nozzle (for removing blocking-prevention powder) and a suction nozzle on a sheet-feeding device.

FIG. 4 is an enlarged schematic diagram of a sheet-fed printing press having, on a printing unit, a blocking-prevention powder removing mechanism by a rotary brush.

FIG. 5 is an enlarged schematic diagram of a sheet-fed printing press having, on a printing unit, a blocking-prevention powder removing mechanism by unwoven fabric.

FIG. 6 is an enlarged schematic diagram of a sheet-fed printing press having, on a printing unit, a blocking-prevention powder removing mechanism by a blade.

### EXPLANATION OF SYMBOLS

1. Printing unit
2. Printing cylinder
3. Blanket cylinder
4. Impression cylinder
5. Intermediate cylinder
6. Swing gripper
7. Compressed air jetting nozzle
8. Sheet feed roll
9. Sheet feed belt
10. Feeder board
11. Sheet feed roller
12. Feeding roller
13. Sheet supply unit
14. Sheet supply section separator
15. Printing paper (whose one side has been printed)
16. Suction nozzle
17. Casing
18. Suction device
19. Compressor
50. Rotary brush
60. Non-woven fabric
61. Non-woven fabric roll
62. Pressure roll
63. Wind-up roll
70. Scraping blade
71. Catch pan

### PREFERRED EMBODIMENT FOR PRACTICING THE INVENTION

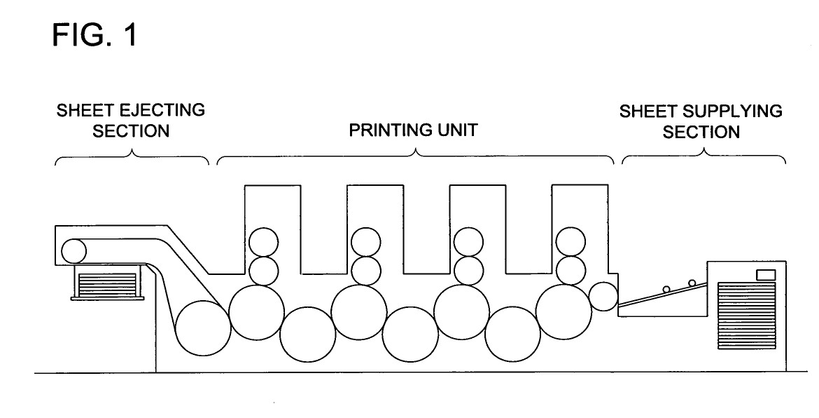

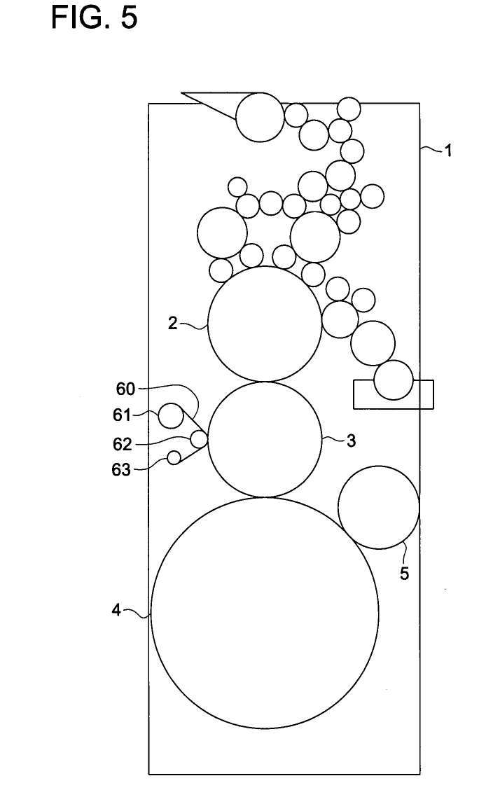

An example of the embodiment relating to the invention will be explained as follows, referring to FIG. 1-FIG. 6, to which, however, the invention is not limited.

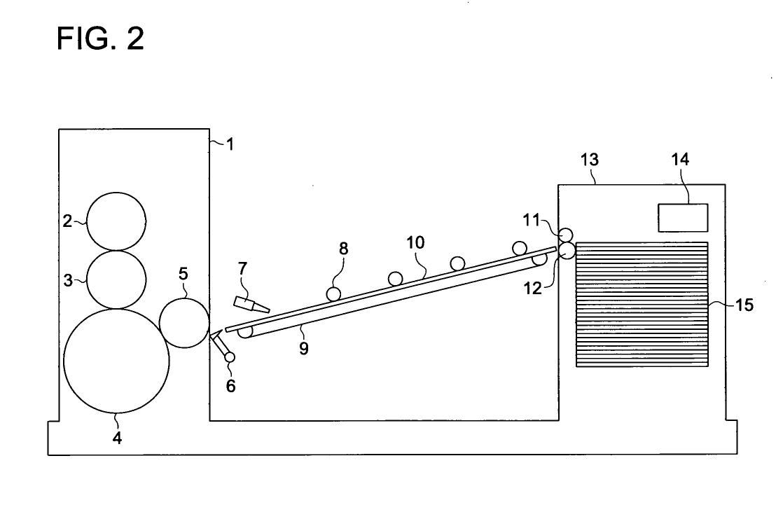

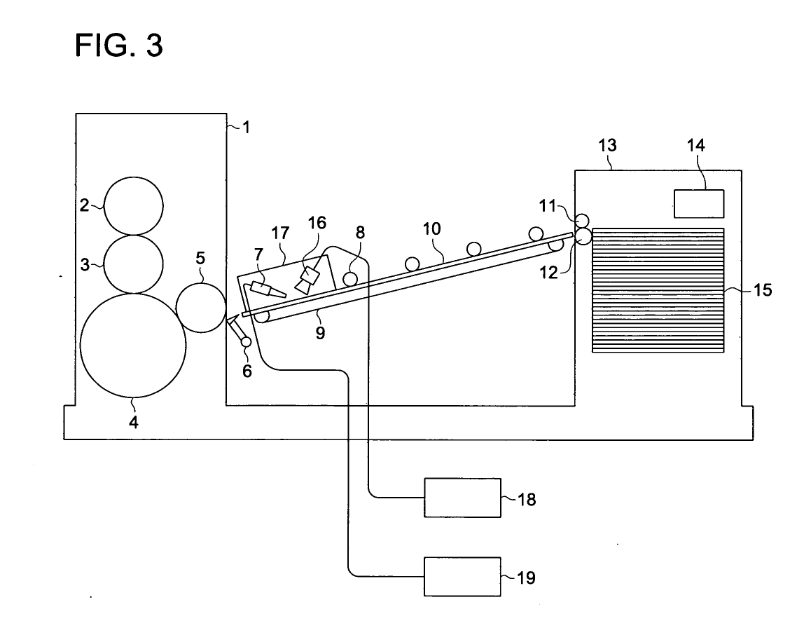

FIG. 1 is a schematic diagram of a sheet-fed printing press used for a printing method of the invention, and sheet-fed printing press is composed of a sheet-feeding device, a printing unit and a sheet ejecting section. Each of FIG. 2 and FIG. 3 represents a sheet-feeding device which is extracted from FIG. 1, and it is a schematic diagram of a printing device having a blocking-prevention powder (hereinafter referred to as “powder”) removing mechanism on a sheet-feeding device.

As a dust-removing means relating to the invention, a means to remove dust by blowing compressed air, or a means to remove dust by scraping it off is preferable.

### (How to Remove Powder on Sheet-Feeding Device)

FIG. 2 is an enlarged schematic diagram of a printing press having a compressed air jetting nozzle (hereinafter referred to as “jetting nozzle”) 7 on the sheet-feeding device. The numeral 1 represents a printing unit and the numeral 13 represents a sheet-feeding unit. First, printing paper 15 (stacked with its reverse side facing upward) which has been printed on its surface is lifted one by one by sheet-feeding section separator 14 to be conveyed to feeder board 10. A feeder portion relating to the invention means a portion where feeder board 10 is in existence and a place from the feeder board to the printing unit. Between a period of time for printing paper 15 to run through the feeder board to arrive at swing gripper 6, power sticking to the printing paper 15 (powder which has stuck in the case of printing on the surface) is blown off by compressed air jetting from jetting nozzle 7. After that, the printing paper 15 is conveyed by the swing gripper 6 to printing unit 1 to be printed on its reverse side, and is ejected. In that case, it is preferable that an orifice of the jetting nozzle 7 is turned to face sheet-feeding unit 13. As an angle for the orifice to be fixed, a range of 5-85° is preferable when a surface to be printed of the printing paper 15 is 0°, and a range of 10-60° is more preferable. Further, the jetting nozzles 7 are arranged to be longer than the total width of printing paper 15. As a distance from printing paper 15, it is preferable that a tip of the nozzle is away from printing paper 15 by 1-50 mm, and it is more preferable to be away by 5-30 mm. Owing to this, it is possible to remove foreign substances such as dust and powder sticking to printing paper 15 effectively.

FIG. 3 is a schematic diagram of a printing press wherein a sheet-feeding device has thereon jetting nozzle 7 and suction nozzle 16 which are housed in casing 17 which is of a box structure. Printing paper 15 whose surface has been printed is lifted one by one by sheet-feeding section separator 14 to be conveyed to a feeder board. Between a period of time for printing paper 15 to run through the feeder board to arrive at swing gripper 6, powder sticking to the printing paper 15 is blown off by compressed air jetted from jetting nozzle 7. The powder thus blown off is sucked by suction nozzle 16 connected to suction device 18 representing a dust-collecting means so that scattering is prevented. The casing 17 plays a role to prevent scattering of powder to a circumference, and it enhances efficiency of blowing off and suction of powder. After that, printing paper 15 is conveyed to printing unit 1 by swing gripper 6 to be printed on its reverse side. In this case, it is preferable that an orifice of the jetting nozzle 7 is turned to face sheet-feeding unit 13. As an angle for the orifice to be fixed, a range of 5-85° is preferable when a surface to be printed of the printing paper 15 is 0°, and a range of 10-60° is more preferable, which is the same as the occasion in FIG. 2. Further, the jetting nozzles 7 are arranged to be longer than the total width of printing paper 15. Suction nozzle 16 is arranged to face jetting nozzle 7, and as an angle for fixing, a range of 3-85° is preferable when a surface to be printed of the printing paper 15 is 0°, and a range of 5-60° is more preferable. Further, it is preferable that the suction nozzle is arranged to have the same angle and the same length as in the case of the jetting nozzle 7. Further, the jetting nozzles 7 are arranged to be longer than the total width of printing paper 15. As a distance from printing paper 15 for the jetting nozzle 7 and suction nozzle 16, it is preferable that a tip of the nozzle is away from printing paper 15 by 1-50 mm, and it is more preferable to be away by 5-30 mm, which is the same as the occasion in FIG. 2. Owing to this, it is possible to remove powder sticking to printing paper 15 effectively without scattering.

With respect to timing for blowing compressed air, it is also possible to blow the compressed air on a pulse pattern basis at the timing for swing gripper 6 to catch the printing paper 15, although it is possible to blow continuously during printing.

### (How to Remove Powder at Printing Unit)

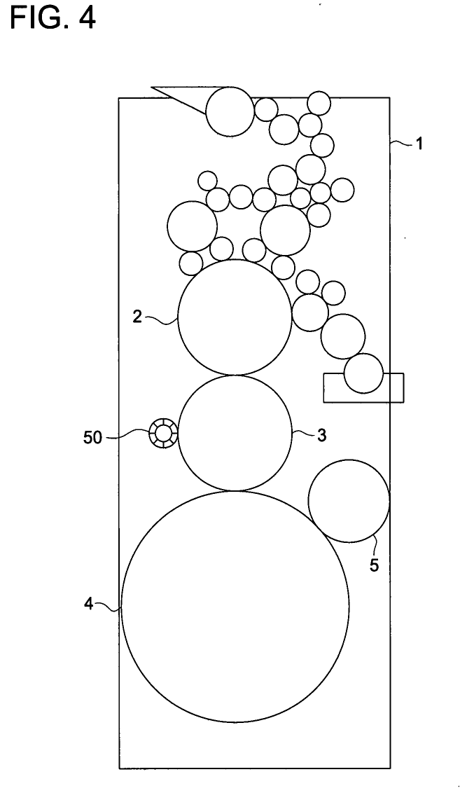

Each of FIGS. 4, 5 and 6 is an enlarged schematic diagram of a printing press having a powder-removing mechanism on each printing unit 1. The numeral 2 represents a printing cylinder on which a printing plate is stuck, 3 represents a blanket cylinder, 4 represents an impression cylinder and 5 represents an intermediate cylinder. First, printing paper 15 whose surface has been printed is lifted one by one by sheet-feeding section separator 14, and passes through feeder board 10 and intermediate cylinder 5 to pass through the space between blanket cylinder 3 and impression cylinder 4. In this case, ink is given from the blanket cylinder and transferring is carried out firmly at impression cylinder 4. Simultaneously with this, powder sticking on printing paper 15 is transferred onto the blanket cylinder 3.

### (Removing by Rotary Brush)

The powder thus transferred is removed from the blanket cylinder by the use of rotary brush 50. Bristles used as materials for the rotary brush include nylon, hog bristles, coconut fibers and others which can be used without any restriction, and nylon among them is preferable. The brush is brought into contact with the blanket cylinder 3 simultaneously with a start of printing. Further, it is preferable that the brush is rotated in the direction opposite to that of the blanket cylinder 3.

### (Removing by Nonwoven Fabric)

The powder thus transferred is removed from the blanket cylinder by the use of nonwoven fabric 60. As a condition in the case of the nonwoven fabric, it is preferable to use nonwoven fabric that is long and is in a roll shape. As a pressure at which the nonwoven fabric 60 is brought into contact with the blanket cylinder 3, 9.8×10⁻³−9.8 N/cm in terms of linear pressure is preferable, and 4.9×10⁻²−7.8 N/cm is more preferable. In the case of removing by means of the nonwoven fabric, the nonwoven fabric can either be brought into contact continuously or be brought into contact intermittently.

If the powder removing by the same position of the nonwoven fabric is continued, efficiency of powder removing is deteriorated. Therefore, nonwoven fabric 60 is rewound gradually so that a fresh portion of the nonwoven fabric may be used constantly for removing of powder. As a rewinding speed in that case for the nonwoven fabric, 0.5-100 cm/min. is preferable, and 1-50 cm/min. is more preferable. Further, it is preferable for nonwoven fabric 60 to rewind in the direction opposite to that of blanket cylinder 3, as in the case of the rotary brush.

### (Removing by Blade)

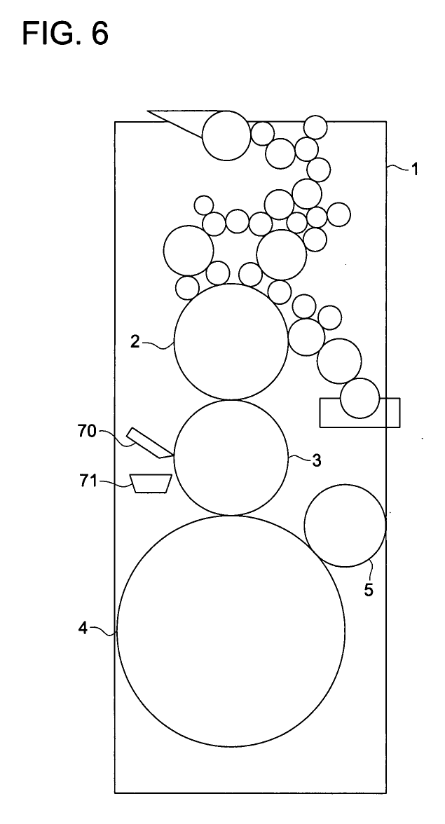

The powder transferred is removed from the blanket cylinder by the use of blade 70. As materials for blade 70, SUS, plastics, hard rubber and others can be used without any restriction, and plastics among them are preferable. The blade 70 is brought into contact with the blanket cylinder 3 simultaneously with a start of printing. As a shape of the blade, it is preferable that the side for removing powder is inclined as shown in FIG. 6. As an angle for the blade 70 to be in contact with blanket cylinder 3, it is preferable that the blade 70 is in parallel with a tangent line passing through an optional one point on the surface of the blanket, and an inclined surface of the blade is in a range of 30-150° when a certain direction of impression cylinder 4 is 0°.

In the invention, it is preferable that the scraping means is any one of the aforesaid rotary brush, unwoven fabric and blade.

### (Where to Mount a Powder-Removing Device)

In the case of a 4-color printing press, for example, when printing units are mounted in the order of the first printing unit, the second printing unit the third printing unit and the fourth printing unit from the sheet-feeding device, it is important to mount beginning with the printing unit on the sheet-feeding device side, when the number of dust-removing devices is less than the number of printing units, although the dust-removing device may be represented by any one of the first-fourth printing units. In particular, mounting on the first printing unit is indispensable. This also applies equally to an offset sheet-fed printing press other than the 4-color printing press.

### (Printing Plate Materials)

Processless printing plates capable of being used in the invention include those which are heretofore known. For example, they are represented by a type that is phase-converted from hydrophilic nature to lipophilic nature through light exposure such as those disclosed in Japanese Patent Publication Open to Public Inspection Nos. 7-1849, 7-1850, 9-311443, 10-6468, 10-114168 and 2000-118160, a type that has an image forming layer having therein thermal melting grains as main components on a hydrophilic support and is processed on a printing press such as those disclosed in Japanese Patent Publication Open to Public Inspection Nos. 9-123387, 9-131850, 2000-221667 and 2000-238451 and a type wherein several layers each having a different affinity are provided, and a surface layer of printing original plate is abraded through light exposure and a layer having affinity different from that on the surface layer is exposed to light for image recording such as those disclosed in Japanese Patent Publication Open to Public Inspection Nos. 7-164773 and 10-193823.

### (Image Forming Method)

Though it is possible to use heat as an embodiment of image forming for printing plate materials, it is preferable especially to conduct image forming through exposure to infrared laser. More specifically, concerning light exposure, scanning exposure using lasers emitting light in infrared and/or near-infrared area, namely, emitting light in wavelength range of 700-1500 nm is preferable. As lasers, though gas lasers may be used, it is especially preferable to use a semiconductor laser emitting light in near-infrared area.

A device suitable for scanning exposure may be a device of any type provided that the device can form images, by using a semiconductor laser, on the surface of a printing plate material based on image signals coming from a computer. However, there are given generally the following three systems as the device suitable for scanning exposure. (1) A system to give exposure to the whole surface of a printing plate material by scanning the printing plate material held by a tabular holding mechanism, on a two-dimensional basis by the use of a single or plural laser beams. (2) A system to give exposure to the whole surface of a printing plate material by scanning the printing plate material held on a cylindrical surface inside a fixed cylindrical holding mechanism in the circumferential direction of a cylinder (main scanning direction) from the inside of the cylinder by the use of a single or plural laser beams, and by moving the printing plate material in the direction perpendicular to the circumferential direction (sub-scanning direction). (3) A system to give exposure to the whole surface of a printing plate material by scanning the printing plate material held on a cylindrical drum surface rotating around a shaft representing a rotating body, in the circumferential direction (main scanning direction) through rotation of the drum from the outside of the cylinder by the use of a single or plural laser beams, and by moving the printing plate material in the direction perpendicular to the circumferential direction (sub-scanning direction).

For the present invention, the scanning exposure system of the aforesaid item (3) is preferable, and an exposure system of the item (3) is used especially for a device wherein an exposure operation is carried out on a printing press.

### EXAMPLES

The invention will be explained specifically as follows, referring to an example to which, however, the invention is not limited. Incidentally, unless otherwise specified, “part” in the Example means “parts by weight” and “%” means “% by weight”.

### Example 1

The printing plate material described in Japanese Patent Publication Open to Public Inspection No. 2005-14409 was prepared in the following procedures.

### <Preparation of Polyethylene Telephthalate Substrate>

By using terephthalic acid and ethylene glycol, polyethylene telephthalate (PET) with IV (inherent viscosity)=0.66 (measured at 25° C. in phenol/tetrachloroethane=6/4 (mass ratio)) was obtained by an ordinary method. This was dried for 4 hours at 130° C., after being pelletized, and then, was melted at 300° C. and then, injected from T-type die, thus, an un-stretched film was prepared. This was subjected to biaxial stretching at a prescribed temperature, and a PET substrate having a thickness of 175±3 μm was prepared.

### (Preparation of Subbed Substrate)

Both sides of the substrate thus obtained were subjected to corona discharge treatment at 8 W/m²·min., and then, coating solution for subbing a with the following composition was coated on the surface on one side in a way to obtain a thickness of dried coating of 0.8 μm, then, coating solution for subbing b was coated in a way to obtain a thickness of dried coating of 0.1 μm, while conducting corona discharge treatment (8 W/m²·min.), and each of the coating solutions was dried at 180° C. for 4 minutes (subbing surface A). Further, coating solution for subbing c with the following composition was coated on the opposite surface in a way to obtain a thickness of dried coating of 0.8 μm, then, coating solution for subbing d was coated in a way to obtain a thickness of dried coating of 1.0 μm, while conducting corona discharge treatment (8 W/m²·min.), and each of the coating solutions was dried at 180° C. for 4 minutes (subbing surface B).

(Coating solution for subbing a)

| Terpolymer latex having | 6.3% (Solid content basis) |
|---|---|
| styrene/glycidylmethacrylate/butylacrylate = | |
| 60/39/1 | |
| Terpolymer latex having styrene/ | 1.6% (Solid content basis) |
| glycidylmethacrylate/butylacrylate = | |
| 20/40/40 | |
| Anion-based surfactant S-1 | 0.1% |
| Water | 92.0% |

(Coating solution for subbing b)

| | |
|---|---|
| Gelatine | 1.0% |
| Anion-based surfactant S-1 | 0.05% |
| Hardening agent H-1 | 0.02% |
| Matting agent (Silica, average particle | 0.02% |
| size 3.5 μm) | |
| Fungicide F-1 | 0.01% |
| Water | 98.9% |

(Coating solution for subbing c)

| | |
|---|---|
| Terpolymer latex having styrene/ | 0.4% (Solid content basis) |
| glycidylmethacrylate/butylacrylate = | |
| 20/40/40 | |
| Quaterpolymer latex having styrene/ | 7.6% (Solid content basis) |
| glycidylmethacrylate/butylacrylate/ | |
| acetoacetoxy ethyl methacrylate = | |
| 39/40/20/1 | |
| Anion-based surfactant S-1 | 0.1% |
| Water | 91.9% |

(Coating solution for subbing d)

| | |
|---|---|
| Conductive composite having component | 6.4 parts |
| d-11/component d-12/component | |
| d-13 = 66/31/1 | |
| Anion-based surfactant S-1 | 0.07 parts |
| Hardening agent H-2 | 0.7 parts |
| Matting agent (Silica, average particle | 0.03 parts |
| size 3.5 μm) | |
| Water | 93.4 parts |

Anionic high molecular compound composed of copolymer with component d-11: sodium styrenesulfonate/maleic acid=50/50 3-component-based copolymerization latex with component d-12: styrene/glycidylmethacrylate/butylacrylate=40/40/20 High molecular activator with component d-13: Styrene/sodium isoprene sulfonate=80/20

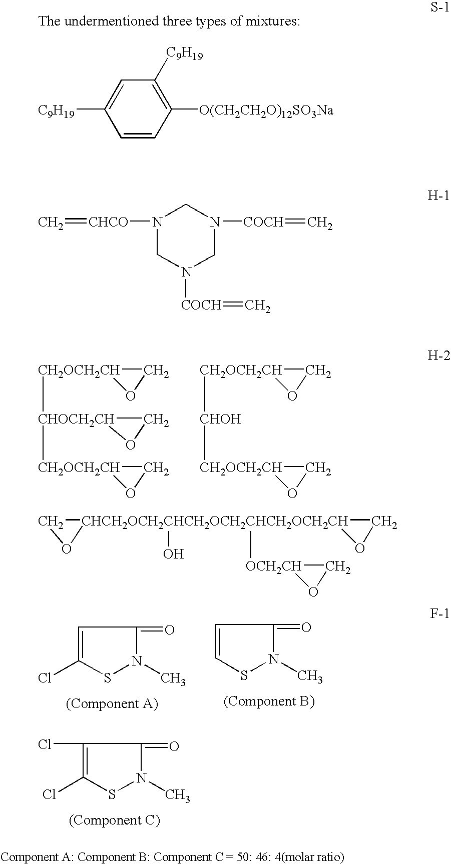

### <Preparation of Materials for a Printing Plate>

A coating solution for hydrophilic layer 1 shown in Table 1, a coating solution for hydrophilic layer 2 shown in Table 2 and a coating solution for the image forming layer shown in Table 3 were coated on subbing surface A of the aforesaid subbed substrate, by the use of a wire bar. In the order of the aforesaid coating, the wire bar was used first in the order of the first hydrophilic layer 1 and the second hydrophilic layer 2 to coat on the substrate in a way to obtain respectively dry weight of 2.5 g/m² and 0.6 g/m², and the hydrophilic layers were subjected to heat treatment at 60° C. for 24 hours after being dried at 120° C. for 3 minutes. After that, in a way to obtain respectively dry weight of 2.5 g/m² and 0.6 g/m², and the hydrophilic layers were subjected to heat treatment at 60° C. for 24 hours after being dried at 120° C. for 3 minutes. After that, a coating solution for the image forming layer shown in Table 3 was coated by the use of a wire bar in a way to obtain dry weight of 0.6 g/m², and seasoning processing was conducted at 40° C. for 72 hours after drying at 50° C. for 3 minutes. The total layer thickness was 180 μm (obtained through measurement by Minicom E-M43RD made by Tokyo Seimitsu Co., Ltd.).

### <Preparation of Coating Solution for Hydrophilic Layer 1>

Respective materials described in Table 1 were sufficiently stirred and mixed by a homogenizer, and then were mixed and filtered at compositions described in Table 1, to prepare a coating solution for hydrophilic layer 1. Numerical values showing mixture ratios of respective materials in the Table are parts by weight.

TABLE 1
Materials

| | |
|---|---|
| Colloidal silica (alkali-based): Snowtex-XS (made by | 68 |
| NISSAN CHEMICAL INDUSTRIES, LTD., solid content 20% by | |
| weight) | |
| STN-6500S made by NISSAN CHEMICAL INDUSTRIES, LTD., | 2 |
| (Average particle size 6.5 μm, A core is made of | |
| melamine resin, and a shell is made of silica) | |
| Cu—Fe—Mn-based metal oxide black pigment: Water- | 7 |
| dispersed-substance with solid content 40% by weight | |
| (0.2% by weight of which is dispersant) of TM-3550 | |
| black dust (made by Dainichiseika Color & Chemicals | |
| Mfg. Co., Ltd., particle size, approx. 0.1 μm) | |
| Stratified mineral particles montmorillonite: Mineral | 8 |
| colloid MO (made by Southern Clay Product Co., average | |
| particle size, approx. 0.1 μm) stirred strongly by a | |
| homogenizer to be water-swelling gel with 5% by weight | |
| Aqueous solution with 4% by weight of sodium carboxy | 5 |
| methyl cellulose (reagent made by KANTO CHEMICAL CO., | |
| INC.) | |
| Aqueous solution with 10% by weight of trisodium | 1 |
| phosphate•12 water (reagent made by KANTO CHEMICAL CO., | |
| INC.) | |
| Porous metal oxide particle Silton JC-40 (made by | 4 |
| MIZUSAWA INDUSTRIAL CHEMICALS, LTD., porous alminate | |
| silicat particle, average particle size 4 μm) | |
| Pure water | 5 |

### <Preparation of Coating Solution for Hydrophilic Layer 2>

Respective materials described in Table 2 were sufficiently stirred and mixed by a homogenizer, and then were mixed and filtered at compositions described in Table 2, to prepare a coating solution for hydrophilic layer 1. Numerical values showing mixture ratios of respective materials in the Table are parts by weight.

TABLE 2
Materials

| | |
|---|---|
| Colloidal silica (alkali-based): Snowtex-S (made by | 17.3 |
| NISSAN CHEMICAL INDUSTRIES, LTD., solid content 30% by | |
| weight) | |
| Necklace-shaped colloidal silica (alkali-based): | 38.7 |
| Snowtex-PSM (made by NISSAN CHEMICAL INDUSTRIES, | |
| solid content 20% by weight) | |
| Matting agent STM-6500S (Irregular surface spherical | 3 |
| particle with average particle size 6.5 μm wherein a | |
| core is made of melamine resin, and a shell is made of | |
| silica; made by NISSAN CHEMICAL INDUSTRIES) | |
| Cu—Fe—Mn-based metal oxide black pigment: Water- | 5 |
| dispersed-substance with solid content 40% by weight | |
| (0.2% by weight of which is dispersant) of TM-3550 | |
| black dust (made by Dainichis Color & Chemicals Mfg. | |
| Co., Ltd., particle size, approx. 0.1 μm) | |
| Stratified mineral particles montmorillonite: Mineral | 8 |
| colloid MO (made by Southern Clay Product Co., average | |
| particle size, approx. 0.1 μm) stirred strongly by a | |
| homogenizer to be water-swelling gel with 5% by weight | |
| Aqueous solution with 4% by weight of (reagent made by | 5 |
| KANTO CHEMICAL CO., INC.) | |
| Aqueous solution with 10% by weight of trisodium | 1 |
| phosphate (reagent made by KANTO CHEMICAL CO., INC.) | |
| Porous metal oxide particle Silton AMT08 (made by | 2.4 |
| MIZUSAWA INDUSTRIAL CHEMICALS, LTD., porous | |
| alminate silicate particle, average particle size 0.6 μm) | |
| Porous metal oxide particle Silton JC-20 (made by | 2 |
| MIZUSAWA INDUSTRIAL CHEMICALS, LTD., porous | |
| alminate silicate particle, average particle size 2 μm) | |
| Porous metal oxide particle Silton JC-50 (made by | 1 |
| MIZUSAWA INDUSTRIAL CHEMICALS, LTD., porous | |
| alminate silicate particle, average particle size 5 μm) | |
| Pure water | 17.6 |

### <Preparation of Coating Solution for Image Forming Layer>

Respective materials described in Table 3 were sufficiently stirred and mixed by a homogenizer, and then were mixed and filtered at compositions described in Table 3, to prepare a coating solution for an image forming layer. Numerical values showing mixture ratios of respective materials in the Table are parts by weight.

TABLE 3
Materials

| | |
|---|---|
| Polysodium acrylate aqueous solution (Brand | 24 parts |
| name: AQUALIC DL453, made by Nihon Shokubai | by weight |
| Co., average molecular weight 50000, solid | |
| content 35% by weight: Water-soluble resin) | |
| Carbodiimide (crosslinking agent) | 1 part by |
| | weight |
| Infrared dye AH-1 | 1 part by |
| | weight |
| Matting agent: Silica (average particle size 3 | 4 parts by |
| μm, coefficient of variation 25%) | weight |
| Carnauba wax emulsion A118 Dispersion liquid | 70 parts |
| wherein solid contents 40% by weight (made by | by weight |
| GIFU CHELLAC CO., average particle size 0.3 μm, | |
| softening point 65° C., melting point 80° C. and | |
| melting viscosity at 140° C. 8 × 10^{-3p} a · s) are | |
| diluted by pure water to solid content 5% by | |
| weight | |

| | |
|---|---|
| | AH-1 |
| 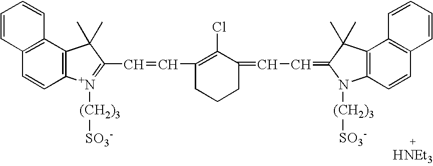 | |

### <Image Forming by Infrared Laser Exposure>

Exposure was given to the aforesaid materials for a printing plate by the use of SS-830 made by Konica Minolta Holdings Inc. Exposure energy was made to be 250 mJ/cm², and a solid image and a 50% halftone image were formed under the conditions of 2400 dpi in the lateral direction (dpi means the number of dots per 1 inch=25.4 cm) and 175-line.

### <Printing>

By using the printing plate thus obtained, printing was carried out (Printing operation Nos. 1-7) by installing an air type device on a sheet-fed printing press under the conditions shown in Table 4. In addition, printing was carried out (Printing operation Nos. 10-14) by installing on a sheet-fed printing press under the conditions shown in Table 5.

### (Printing Conditions)

Printing press: DAIYA 1F-1 made by MITSUBISHI HEAVY INDUSTRIES, LTD.

Printing paper: Mu coat (made by HOKUETSU PAPER MILS, LTD., 104.7 g/m²)

Aqueous dampening solution: ASTROMARK 3 (made by Nikken Kagaku Kenkyusho) 2% solution

Ink: Toyo King HYECOO Magenta (made by TOYO INK MFG. CO. LTD.) was used for printing. After exposure, the printing plate material was installed as it is on the printing cylinder, and the same print-starting sequence as that in the presensitized plate was used for printing.

### <Evaluation>

A plate life was evaluated for each image thus printed. Results of the evaluation are shown in Table 4 and Table 5.

### <<Plate Life>>

The number of prints at the moment when blurring started on a 50% halftone image or on a solid image was used as an index for the plate life. Those having the 10,000 prints or more were accepted.

TABLE 4

| | Air | Distance | Angle | |
|---|---|---|---|---|
| Printing | jetting | to paper | formed by | Plate life |
| operation No. | device | (mm) | paper | (prints) |
| 1 | None | — | — | 3,000 |
| (Comparative | | | | |
| Eample) | | | | |
| 2 (Present | A | 15 | 45° | 10,000 or more |
| invention) | | | | |
| 3. (present | A | 55 | 45° | 6,000 |
| invention) | | | | |
| 4 (Present | A | 15 | 90° | 7,000 |
| invention) | | | | |
| 5 (Present | B | 15 | 45° | 10,000 or more |
| invention) | | | | |
| 6 (Present | B | 55 | 45° | 7,000 |
| invention) | | | | |
| 7 (Present | B | 15 | 90° | 8,000 |
| invention) | | | | |

TABLE 5

| Printing | Scraping | | |
|---|---|---|---|
| operation No. | device | Mounting section | Plate life |
| 10 (Comparative | None | — | 3,000 |
| Eample) | | | |
| 11 (present | Brush | First printing | 10,000 or more |
| invention) | | unit | |
| 12 (present | Unwoven | First printing | 10,000 or more |
| invention) | fabric | unit | |
| 13 (present | Unwoven | Total printing | 10,000 or more |
| invention) | fabric | units | |
| 14 (present | Blade | First printing | 10,000 or more |
| invention) | | unit | |

It is understood from tables 4 and 5 that printing that is excellent in plate life can be conducted by using the sheet-fed printing press of the invention.

1. A sheet-fed printing press of a single-sided printing type, comprising:
a printing unit; and
a sheet-feeding device section having a feeder section that feeds a sheet to the printing unit;
wherein at least one of the feeder section and the printing unit has a dust-removing device.

2. The sheet-fed printing press of claim 1,
wherein the dust-removing device is a device to remove dust by jetting compressed air.

3. The sheet-fed printing press described of claim 1
wherein the dust-removing device is a device to remove dust by scraping.

4. The sheet-fed printing press of claim 3,
wherein the dust-removing device is at least one type selected from a brush, an unwoven fabric and a blade.

5. The sheet-fed printing press of claim 1, further comprising a dust-collecting device.

6. The sheet-fed printing press of claim 5, wherein the dust-removing device and the dust-collecting device are provided in a casing that is totally of a box structure.

7. A printing method to conduct double-sided printing by using the sheet-fed printing press of claim 1, comprising steps of:
printing on one side of a sheet;
supplying blocking-prevention powder onto the one side of the sheet carrying printed images;
removing the blocking-prevention powder on a reverse surface of the sheet by at least one of the feeder section and the printing unit; and
printing on the reverse surface of the sheet
